(19) United States
(12) Patent Application Publication
(10) Pub. No.: US 2016/0112183 A1
(43) Pub. Date: Apr. 21, 2016

(54) SIGNAL SAMPLING TIMING DRIFT COMPENSATION

(71) Applicant: QUALCOMM Incorporated, San Diego, CA (US)

(72) Inventors: Michael DROP, San Diego, CA (US); Dexter Tamio CHUN, San Diego, CA (US)

(21) Appl. No.: 14/518,587

(22) Filed: Oct. 20, 2014

(51) Int. Cl. H04L 7/00; H04L 7/033

(52) U.S. Cl. CPC H04L 7/0016; H04L 7/033

(57) ABSTRACT

Method and apparatus for signal sampling timing drift compensation are provided. Raw time values or deviations between clock and data are measured and filtered to generate filtered time information, and the filtered time information is compared to an upper bound and a lower bound. If the filtered time information is outside the upper and lower bounds, then an amount of timing compensation for the clock is computed. A signal is sent to reset the clock based on the amount of timing compensation.

### FIELD OF DISCLOSURE

Various embodiments described herein relate to signal sampling, and more particularly, to signal sampling timing drift compensation.

### BACKGROUND

Transfer of data in high-speed communications requires accurate timing of clock signals. As the frequency of operation for system interfaces continually increases, timing tolerances become progressively tighter as smaller margins for error are allowed when data is transferred. Reliable transfer of data over an interface typically requires, at a minimum, that a window or “eye” be provided where the data value remains stable and correct, and that such a window or “eye” be reliably sampled at its center, or alternatively, a position where the data has a maximum likelihood of being the correct value.

In practice, however, timing drift caused by various factors, such as system jitter, temperature change or supply voltage variation, for example, may introduce uncertainty in the sampling process, causing the sampling point to drift off center. As the frequency of data transfer increases, the window becomes smaller, and drift may often become more problematic. In lower frequencies of operation, system designers have allowed the window to be tolerant of off-center sampling to some extent, by making the window wide enough to tolerate imprecision in window alignment.

Moreover, various schemes have been devised in attempts to alleviate the effect of timing drift in transfers of data at higher frequencies. For example, one such scheme utilizes a training method in which a transmitting device sends a test pattern over a communication link and is gradually shifted in time for a receiving device to find a center sampling position. Shifted test patterns are transmitted periodically to compensate for the drift. However, such test patterns can only be sent when no other data is being transmitted over the same link, thereby resulting in bus interface downtime in order to allow the transmitting device to send the test patterns and train the receiving device for timing compensation. Such interface downtime results in inefficient data transfer and waste of valuable time and power.

There is a need to develop a method which can keep the sampling point centered without having to stall the mission-mode data traffic.

### SUMMARY

Exemplary embodiments are directed to apparatus and method for signal sampling timing drift compensation.

In an embodiment, a method of compensating for signal sampling timing drift is provided, the method comprising: measuring raw time values between a clock and data; filtering the measured raw time values to generate filtered time information; comparing the filtered time information to an upper bound and a lower bound; and based upon a determination that the filtered time information is outside the upper bound and the lower bound, computing an amount of timing compensation based upon the filtered time information; and sending a signal to reset the clock based upon the amount of timing compensation.

In another embodiment, a method for compensating for signal sampling timing drift is provided, the method comprising the steps for: measuring raw time values between a clock and data; filtering the measured raw time values to generate filtered time information; comparing the filtered time information to an upper bound and a lower bound; and based upon a determination that the filtered time information is outside the upper bound and the lower bound, performing the steps for: computing an amount of timing compensation based upon the filtered time information; and sending a signal to reset the clock based upon the amount of timing compensation.

In another embodiment, an apparatus for compensating for signal sampling timing drift is provided, the apparatus comprising: means for measuring raw time values between a clock and data; means for filtering the measured raw time values to generate filtered time information; means for comparing the filtered time information to an upper bound and a lower bound; means for computing an amount of timing compensation based upon the filtered time information if the filtered time information is outside the upper bound and the lower bound; and means for sending a signal to reset the clock based upon the amount of timing compensation.

In yet another embodiment, a non-transitory machine-readable storage medium encoded with instructions executable to perform operations to compensate for signal sampling timing drift is provided, the instructions comprising instructions to: measure raw time values between a clock and data; filter the measured raw time values to generate filtered time information; compare the filtered time information to an upper bound and a lower bound; and based upon a determination that the filtered time information is outside the upper bound and the lower bound, compute an amount of timing compensation based upon the filtered time information; and sending a signal to reset the clock based upon the amount of timing compensation.

### BRIEF DESCRIPTION OF THE DRAWINGS

The accompanying drawings are presented to aid in the description of embodiments of the disclosure and are provided solely for illustration of the embodiments and not limitations thereof.

FIG. 1 is a block diagram illustrating an embodiment of data transfer between a system-on-a-chip (SoC) and a memory to which an embodiment of a method for signal sampling timing drift compensation is applicable.

FIG. 2 is a circuit diagram illustrating an embodiment of a timing drift measurement block for implementing an embodiment of a method for signal sampling timing drift compensation.

FIG. 3A is a timing diagram illustrating a proper sampling position in an embodiment in which the time information is represented as a raw voltage of an analog signal.

FIG. 3B is a timing diagram illustrating an improper sampling position where the clock has drifted off center in an embodiment in which the time information is represented as a raw voltage of an analog signal.

FIG. 4 is a timing diagram illustrating a proper sampling position in an alternate embodiment in which the time information is digitized.

FIG. 5 is a flowchart illustrating an embodiment of a method for signal sampling timing drift compensation.

### DETAILED DESCRIPTION

Aspects of the disclosure are described in the following description and related drawings directed to specific embodiments. Alternate embodiments may be devised without departing from the scope of the disclosure. Additionally, well known elements will not be described in detail or will be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of the embodiments. As used herein, the singular forms “a,” “an,” and “the,” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise.

Furthermore, many embodiments are described in terms of sequences of actions to be performed by, for example, elements of a computing device. It will be recognized that various actions described herein can be performed by specific circuits, such as application specific integrated circuits (ASICs), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Moreover, terms such as “transmitter” and “receiver” are intended to encompass any system, apparatus, device, component, structure, hardware, software, firmware, or any combination thereof, that are capable of, respectively, transmitting and receiving digital or analog signals, data, instructions, commands, information, bits, symbols, chips, or any combination thereof. Transmission and reception of signals, data, instructions, commands, information, bits, symbols, chips, or any combination thereof may occur over one or more analog or digital communication links, including but not limited to wireless links, wired links, optical fiber links, data buses or computer interfaces.

Although exemplary embodiments of the disclosure are described with respect to signal sampling timing drift compensation over communication links between components of a computer, for example, between a system-on-a-chip (SoC) in which a central processing unit (CPU) is embedded and a memory, such as a dynamic random access memory (DRAM), it will be understood by persons skilled in the art that the principles disclosed herein are also applicable to timing drift compensation over various other communication links.

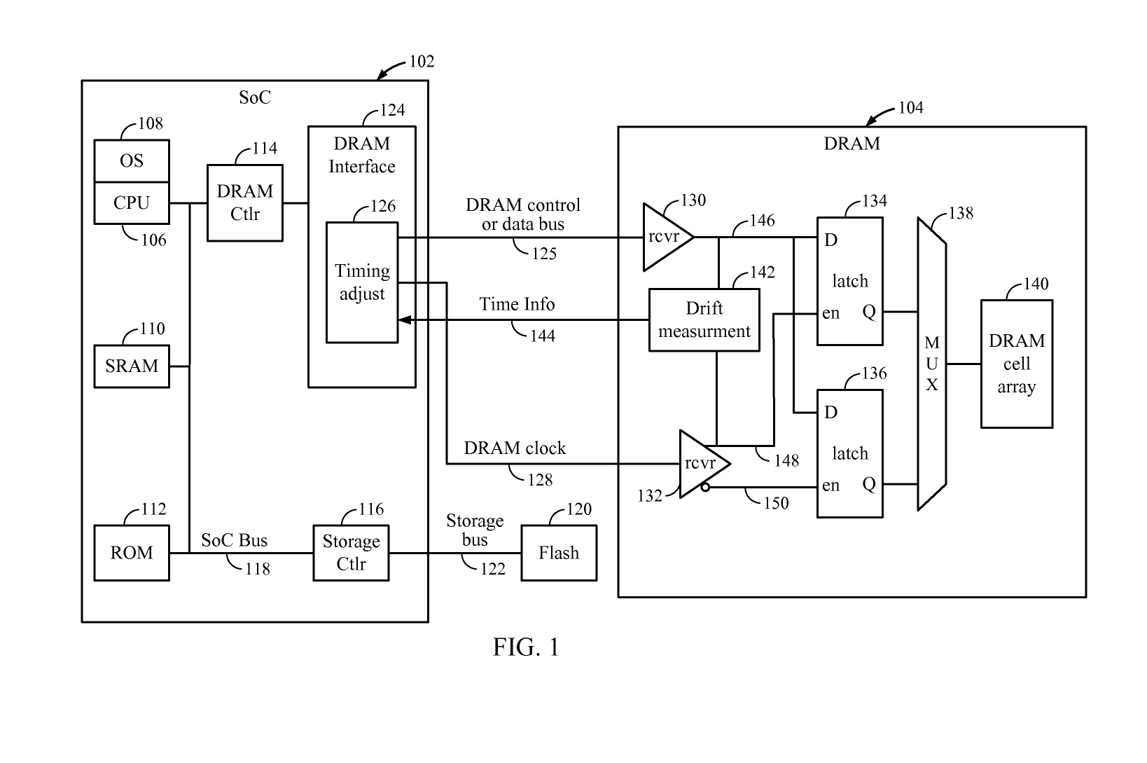

FIG. 1 is a block diagram illustrating an embodiment of data transfer between a system-on-a-chip (SoC) 102 and a memory, such as a dynamic random access memory (DRAM) 104, to which an embodiment of a method for signal sampling timing drift compensation is applicable. In the embodiment shown in FIG. 1, the SoC 102 is implemented on a single chip which includes a microprocessor or a central processing unit (CPU) 106 and an operating system 108 associated with the CPU 106. In addition, the SoC 102 may also include a static random access memory (SRAM) 110, a read only memory (ROM) 112, a DRAM controller 114, and a storage controller 116. An SoC bus 118 may be provided in the SoC 102 to connect some or all of these components, namely, the CPU 106, the SRAM 110, the ROM 112, the DRAM controller 114 and the storage controller 116. Moreover, a flash memory 120, which may be a removal memory chip outside the SoC 102 in an embodiment, may be connected to the storage controller 116 inside the SoC 102 through a storage bus 122.

In an embodiment, a DRAM interface 124 is also provided in the SoC 102. A DRAM control or data bus 125 is connected to the DRAM interface 124 to provide links for transmitting control signals and data to another device, such as the DRAM 104. In a further embodiment, a timing adjustment block 126 is provided in the DRAM interface 124 to adjust the timing of clock pulses in response to time information received from another device that receives the clock pulses. In an embodiment, the DRAM control or data bus 125 is connected to the timing adjustment block 126 within the DRAM interface 124. In a further embodiment, a DRAM clock bus 128 is connected to the timing adjustment block 126 within the DRAM interface 124 to provide clock pulses to the DRAM 104. Alternatively, the timing adjustment block 126 may be provided outside the DRAM interface 124 in another part of the SoC 102.

In an embodiment, the DRAM 104 includes a first receiver 130 connected to the DRAM control or data bus 125 to receive control signals as well as data from the DRAM interface 124 in the SoC 102. In an embodiment, the DRAM 104 also includes a second receiver 132 connected to the DRAM clock bus 128 to receive clock pulses from the timing adjustment block 126 of the DRAM interface 124. In a further embodiment, a first latch 134 and a second latch 136 may be provided in the DRAM 104. The first and second latches 134 and 136 may be gated D latches with a data input “D,” a clock input “en,” and an output “Q,” for example. In an embodiment, a multiplexer 138 is connected to the Q outputs of the first and second latches 134 and 136. In a further embodiment, a DRAM cell array 140 is connected to the output of the multiplexer 138.

In an embodiment, a timing drift measurement block 142 is provided in the DRAM 104 to provide time information as a feedback to the timing adjustment block 126 of the DRAM interface 124 in the SoC 102. The time information may be fed back to the timing adjustment block 126 through a communication link 144, which may be a dedicated wire or a line in an existing interface, for example. In other embodiments, the link 144 for sending the time information from the timing drift measurement block 142 to the timing adjustment block 126 may be a wireless link, an optical link, or another type of link that is capable of conveying analog signals or digital data.

In an embodiment, the first receiver 130 in the DRAM 104 which receives DRAM control signals or data through the DRAM control or data bus 125 has an output 146 connected to the D inputs of the first and second latches 134 and 136 as well as the timing drift measurement block 142. In an embodiment, the second receiver 132 in the DRAM 104 which receives DRAM clock pulses through the DRAM clock bus 128 has an output 148 connected to the clock or “en” input of the first latch 134 as well as the timing drift measurement block 142. In a further embodiment, the second receiver 132 also has a complementary output 150 connected to the clock or “en” input of the second latch 136. In an embodiment, the timing drift measurement block 142 receives both clock pulses from the second receiver 132 and the data from the first receiver 130 to measure time drift between clock pulses and data bits.

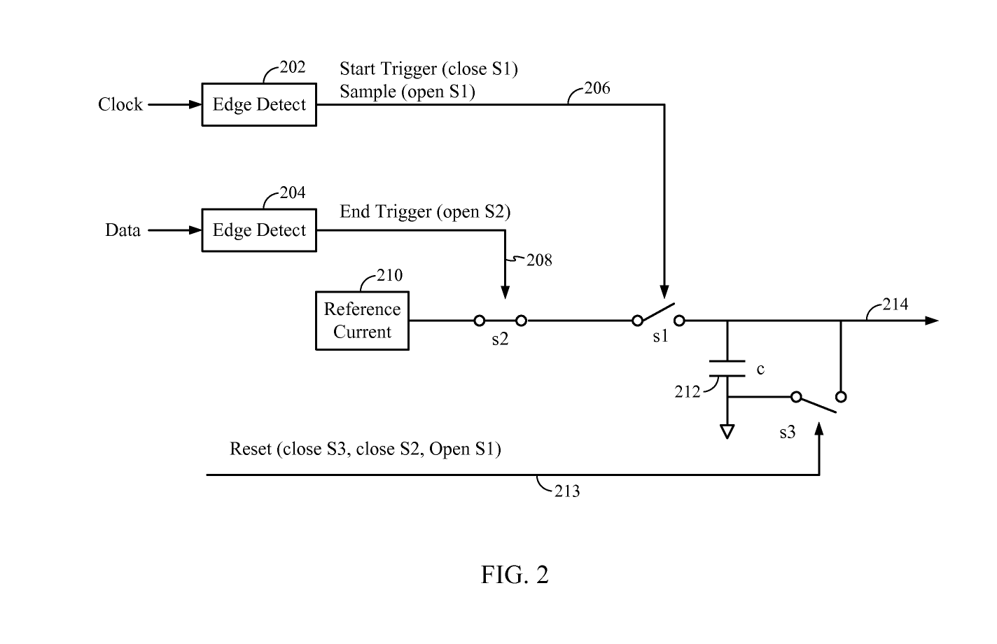

FIG. 2 is a circuit diagram illustrating an embodiment of a timing drift measurement block, such as the timing drift measurement block 142 in a DRAM 104 in the embodiment shown in FIG. 1, for implementing an embodiment of a method for signal sampling timing drift compensation. In the embodiment shown in FIG. 2, clock pulses are received by a first edge detector 202, and data bits are received by a second edge detector 204. In other embodiments, detections of relative positions of a clock pulse and a respective data bit may be achieved in manners other than edge detection. For example, the centers of clock pulses and data bits instead of the edges may be detected in alternate embodiments. Referring to FIG. 2, in which edge detectors 202 and 204 are implemented to detect edges of clock pulses and data bits, respectively, the first edge detector 202 may generate a start trigger at the rising edge of a clock pulse and a sampling signal at the falling edge of the clock pulse at the output 206 of the first edge detector 202. Moreover, the second edge detector 204 may generate an end trigger at the edge of each data bit, regardless of whether it is a rising edge or a falling edge, at the output 208 of the second edge detector 204.

In the embodiment shown in FIG. 2, a reference current is provided by a reference current generator 210 to a switch S2, which is controlled by the output 208 of the second edge detector 204. In an embodiment, an end trigger generated by the second edge detector 204 in response to detecting the edge of a data bit, regardless of whether the edge of the data bit is rising or falling, opens the switch S2. In addition, another switch S1, which is controlled by the output 206 of the first edge detector 202, is connected in series with the switch S1 to the reference current generator 210. In an embodiment, a start trigger generated by the first edge detector 202 in response to detecting the rising edge of a clock pulse closes the switch S1, whereas a sampling signal generated by the first edge detector 202 in response to detecting the falling edge of a clock pulse opens the switch S1.

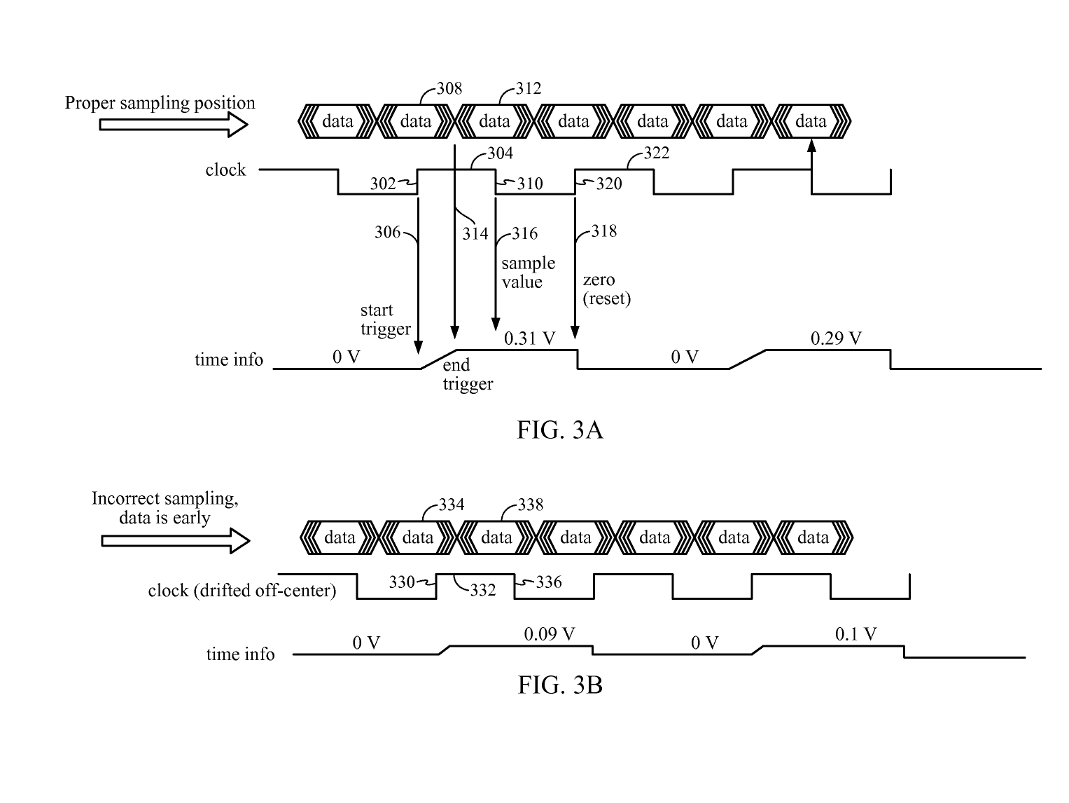

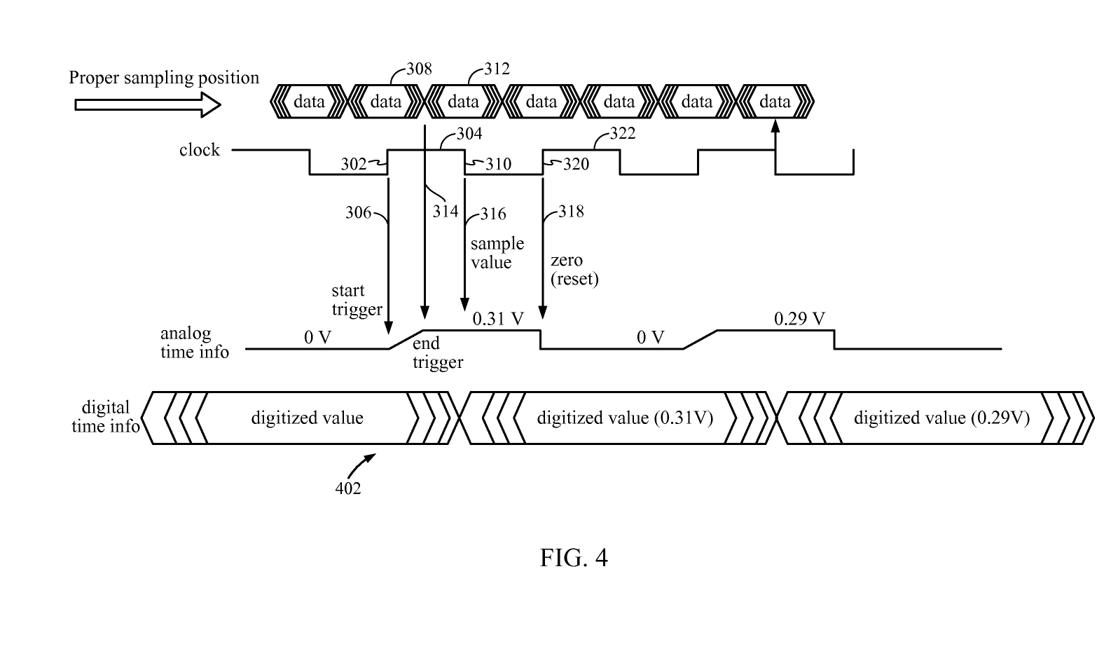

In the embodiment shown in FIG. 2, the timing drift measurement block also includes a capacitor 212 connected between the switch S1 and ground, and a third switch S3 connected to the ground terminal of the capacitor 212. In an embodiment, a reset signal controls the switch S3 through a reset line 213. In an embodiment, the reset signal may be timed to open the switch S3 at the start of a subsequent clock pulse after a sampling signal is transmitted by the first edge detector 202 at the falling edge of a previous clock pulse to sample the center of a respective data bit relative to the falling edge of the previous clock pulse to detect any timing drift, for example. An example of sampling of the center of a data bit in relation to the falling edge of a respective clock pulse to detect timing drift of the data bit with respect to the clock pulse will be described in further detail with respect to FIGS. 3A, 3B and 4.

In an embodiment, not every consecutive data bit and every corresponding clock pulse need to be sampled. The reset signal may be programmed such that sampling is performed in one of every two clock pulses, for example. Sampling of data drift may be performed even less frequently, for example, once every three or four clock pulses, for example. In the embodiment shown in FIG. 2, the capacitor 212 serves as a low pass filter to filter out spurious measured samples of timing drift because there may be various in the measured samples from trigger to trigger. Spurious samples may be removed in other manners or by other types of filters known to persons skilled in the art. In the embodiment shown in FIG. 2, the output 214 from the low pass filter which comprises the capacitor 212 may be an analog time information signal indicating timing drift. For example, the output 214 may be a raw voltage whose voltage value is proportional to the time offset between the clock and the data. Alternatively, the voltage level of the output 214 may indicate the amount of time offset between the clock and the data in a corresponding relationship without being directly proportional.

FIG. 3A is a timing diagram illustrating a proper sampling position in an embodiment in which the time information is represented as a raw voltage of an analog signal. In FIG. 3A, it is assumed that the data bits would be perfectly aligned with the corresponding clock pulses, that is, with zero time drift, if the rising or falling edge of a given clock pulse is exactly aligned with the center of a respective data bit. Referring to FIG. 3A, the rising edge 302 of a clock pulse 304 causes the first edge detector 202 as shown in FIG. 2 to generate a start trigger 306 as shown in FIG. 3A. Ideally, the rising edge 302 of the clock pulse 304 would perfectly coincide with the center of data bit 308, whereas the falling edge 310 of the clock pulse 304 would perfectly coincide with the center of the immediately succeeding data bit 312.

Referring to FIG. 3A, the end of the data bit 308 causes the second edge detector 204 as shown in FIG. 2 to generate an end trigger 314 as shown in FIG. 3A. In an embodiment, the falling edge 310 of the clock pulse 304 causes the first edge detector 202 as shown in FIG. 2 to generate a sampling signal 316 as shown in FIG. 3A, to measure or sample the time which ideally would be the center of the data bit 312. In an embodiment, the time information may be represented by an analog signal having a parameter, such as a raw voltage, to indicate a time offset between the falling edge 310 of the clock pulse 304 and the center of the data bit 312. For example, in the embodiment shown in FIG. 3A, a voltage level of about 0.3V may indicate a perfect or near perfect alignment of the rising or falling edge of a clock pulse and the corresponding center of a data bit, whereas a voltage level of 0V may indicate either non-alignment or a time interval in which the time information is not measured or sampled.

In the embodiment shown in FIG. 3A, after the time information is sampled upon triggering of the sampling signal 316 at the falling edge 310 of the clock pulse 304, a reset signal 318 is sent at the rising edge 320 of the immediately succeeding clock pulse 322, to direct the time drift measurement block to stop sampling or measuring the time drift for the next data bit or next several data bits. Moreover, because the time information in FIG. 3A is represented by an analog voltage signal, the voltage level may vary slightly between different samples or measurements even if there is little or no timing drift. For example, one sample may produce a voltage level of 0.31V whereas a subsequent sample may produce a voltage level of 0.29V as shown in FIG. 3A. Low pass filtering may be applied to filter out spurious signals or jitters if the time information is carried as an analog signal to indicate timing drift.

FIG. 3B is a timing diagram illustrating an improper sampling position where the clock has drifted significantly off center in an embodiment in which the time information is represented as a raw voltage of an analog signal. As shown in FIG. 3B, the rising edge 330 of a clock pulse 332 is far off the center of the corresponding data bit 334 by a significant time delay, and likewise, the falling edge 336 of the clock pulse 332 is far off the center of the corresponding data bit 338 by a significant time delay. In FIG. 3B, the delay of the edge of a clock pulse with respect to the center of a corresponding data bit, or, in other words, the advancement of the center of a data bit with respect to the corresponding edge of a clock pulse in the time domain, causes the sampled voltages to be much lower than the sampled voltages in case of perfect or near perfect alignment.

For example, compared to the sampled voltages of 0.31V and 0.29V in case of perfect or near perfect alignment in FIG. 3A, the sampled voltages are much lower at 0.09V and 0.1V in FIG. 3B, where the center of each data bit arrives much earlier than the edge of a corresponding clock pulse. On the other hand, if the arrival of the center of each data bit is much later than the edge of a corresponding clock pulse, the analog signal whose voltage level represents the time drift between the clock and the data may be much higher than 0.3V, which represents perfect or near perfect alignment of the edges of the clock pulses and the centers of the data bits as shown in FIG. 3A. In alternate embodiments, time information for indicating timing drifts between clock and data may be represented by parameters such as voltage or current values in manners apparent to persons skilled in the art.

FIG. 4 is a timing diagram illustrating a proper sampling position in an alternate embodiment in which the time information is digitized by the DRAM before it is transmitted to the SoC. In FIG. 4, the start trigger 306, the end trigger 314, the sampling signal 316 to trigger the sampling or measurement of time drift value, and the reset signal 318 to end time drift sampling or measurement for the next data bit or next several data bits are identical to those illustrated in FIG. 3A and described above. Again, the sampled or measured timing drift is represented by an analog signal whose voltage represents the amount of time drift between the data bit and the clock pulse in the same manner as illustrated in FIG. 3A and described above. In the embodiment shown in FIG. 4, however, the analog voltage signal is digitized into a digital signal, for example, a number indicating the voltage level representing the time drift information, before it is transmitted from the timing drift measurement block 142 in the DRAM 104 to the timing adjustment block 126 in the SoC 102 in FIG. 1.

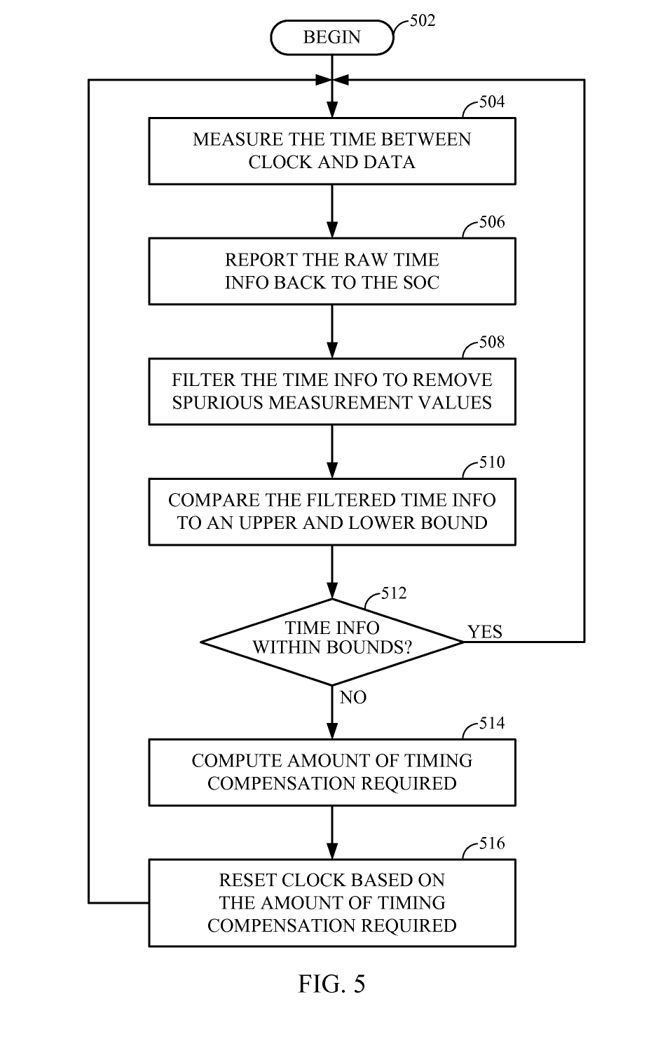

FIG. 5 is a flowchart illustrating an embodiment of a method for signal sampling timing drift compensation. Such a method may be implemented a software algorithm, a firmware structure, or a hardware apparatus or circuit in which the algorithm is hardwired in manners apparent to persons skilled in the art. Referring to FIG. 5, the algorithm begins at step 502. In an embodiment, the time between clock and data, which may be either a delay or an advancement of time of arrival of a data bit with respect to a corresponding clock pulse, is measured in step 504. Such raw measurements or samplings of time between clock and data may be performed continuously, or alternatively, once every two clock pulses or once every several clock pulses in various embodiments. In an embodiment, such raw measurements of time information between the clock and the data may be transmitted from the timing drift measurement block 142 in the DRAM 104 to the timing adjustment block 126 in the SoC 102 as shown in FIG. 1 continuously, or alternatively, once every two clock pulses or once every several clock pulses in step 506.

Referring to the flowchart of FIG. 5, the raw measured time information may be filtered to remove spurious measurement values in step 508. The raw measurements may be filtered by a low pass filter, such as a filter with a capacitor 212 as shown in FIG. 2 and described above. Unreliable or spurious measured values may be filtered out or removed in various manners in alternate embodiments. The filtered time information is then compared to an upper bound and a lower bound in step 510 to determine whether the time drift between the clock and the data as indicated by the filtered time information is within or outside the upper and lower bounds. If it is determined that the time drift is within the upper and lower bounds in step 512, then the timing drift measurement block repeats steps 504-510 by continuing to measure the time drift between clock and data as in step 504, report the measured time drift in step 506, filter the raw measured time drift information to remove spurious measurement values in step 508, and compare the filtered time information to the upper and lower bounds again in step 510.

If, however, it is determined that the time drift is outside the upper and lower bounds in step 512, then the timing drift measurement block computes the amount of timing compensation required to reset the clock in step 514. The timing drift measurement block may then send a signal to the timing adjustment block to reset the clock based upon the amount of timing compensation required in step 516. In an embodiment, the clock may be reset by sending a new series of clock pulses from the timing adjustment block 126 in FIG. 1, for example, by taking into account the amount of timing compensation required to offset the timing drift measured by the timing drift measurement block 142 based on previous clock pulses.

Referring to FIG. 5, after the timing adjustment block resets the clock, steps 504-510 are repeated by continuing to measure the time drift between clock and data as in step 504, report the measured time drift in step 506, filter the raw measured time drift information to remove spurious measurement values in step 508, and compare the filtered time information to the upper and lower bounds again in step 510.

In an embodiment, the upper and lower bounds for the time drift used for deciding whether to reset the clock may be set as the amount of time drift allowed as a predetermined fraction of the length of a clock pulse. For example, in the embodiments described above in which the center of a data bit is measured with respect to the falling edge of a respective clock pulse, a deviation of 0% means that the falling edge of the clock pulse is exactly at the center of the data bit. An upper bound may be set at +20% of a length of the clock pulse, that is, where the center of a data bit is in advance of the falling edge of the respective clock pulse by 20% of the length of the clock pulse. Similarly, a lower bound may be set at −20% of the length of the clock pulse, that is, where the center of the data bit is behind the falling edge of the respective clock pulse by 20% of the length of the clock pulse. In an alternate embodiment, the rising edge instead of the falling edge of a clock pulse may be compared to the center of a respective data bit.

In an embodiment, if it is determined that the deviation between the rising or falling edge of a clock pulse and the center of a respective data bit is outside the upper and lower bounds, the clock may be reset by sending a series of new clock pulses by taking into account the amount of compensation required. For example, if it is determined that the center of a data bit is in advance of the falling edge of a respective clock pulse by 30% of the length of the clock pulse, which is outside the upper bound of 20% in the example described above, then an advance adjustment or compensation of 30% of the length of the clock pulse is required for the new clock pulses. In an embodiment, the clock may be reset by advancing or delaying either the rising edge or the falling edge of each clock pulse by the amount of compensation required such that the rising or falling edge of each clock pulse in the series of new clock pulses is aligned with the center of a respective data bit.

Although specific embodiments have been described with respect to timing drift measurement and adjustment for data transfer between a computer SoC 102 and a DRAM 104 as shown in FIG. 1, the principles disclosed by the foregoing description are also applicable to various other systems. For example, instead of being embedded in a SoC 102, the timing adjustment block 126 may be implemented in any transmitter of data and clock. Likewise, instead of being embedded in a DRAM 104, the timing drift measurement block 142 may be implemented in any receiver of data and clock. Moreover, instead of transmitting the time information for adjusting clock signals to compensate for timing drifts unidirectionally as shown in FIG. 1, the time information may be exchanged bidirectionally if data also flows from the DRAM 104 to the SoC 102, for example.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the disclosure may include a computer readable medium embodying a method for compensating signal sampling timing drift. Accordingly, the scope of the appended claims is not limited to illustrated examples and any means for performing the functionality described herein are included in embodiments of the disclosure.

While the foregoing disclosure describes illustrative embodiments, it should be noted that various changes and modifications could be made herein without departing from the scope of the appended claims. The functions, steps or actions in the method and apparatus claims in accordance with the embodiments described herein need not be performed in any particular order unless explicitly stated otherwise. Furthermore, although elements may be described or claimed in the singular, the plural is contemplated unless limitation to the singular is explicitly stated.

What is claimed is:

1. A method of compensating for signal sampling timing drift, the method comprising:
measuring raw time values between a clock and data;
filtering the measured raw time values to generate filtered time information;
comparing the filtered time information to an upper bound and a lower bound; and
based upon a determination that the filtered time information is outside the upper bound and the lower bound,
computing an amount of timing compensation based upon the filtered time information; and
sending a signal to reset the clock based upon the amount of timing compensation.

2. The method of claim 1, further comprising:
repeating the steps of
measuring raw time values between a clock and data;
filtering the measured raw time values to generate filtered time information; and
comparing the filtered time information to an upper bound and a lower bound,
after sending the signal to reset the clock based upon the amount of timing compensation.

3. The method of claim 1, further comprising:
based upon a determination that the filtered time information is inside the upper bound and the lower bound, repeating the steps of:
measuring raw time values between a clock and data;
filtering the measured raw time values to generate filtered time information; and
comparing the filtered time information to an upper bound and a lower bound.

4. The method of claim 1, wherein filtering the measured raw time values to generate filtered time information comprises removing one or more spurious time measurement values from the measured raw time values.

5. The method of claim 1, wherein the data comprise a plurality of data bits, each of the data bits having a predetermined length and a center in a time domain, and wherein computing the amount of timing compensation based upon the filtered time information comprises comparing the center of a respective one of the data bits to a respective one of a plurality of clock pulses.

6. The method of claim 5, wherein comparing the center of a respective one of the data bits to a respective one of a plurality of clock pulses comprises comparing the center of a respective one of the data bits to a clock edge of a respective one of the plurality of clock pulses.

7. The method of claim 6, wherein the upper bound is a time delay of a fraction of a width of a clock pulse from the center of a respective one of the data bits to the clock edge of a respective one of the plurality of clock pulses, and wherein the lower bound is a time advancement of a fraction of a width of a clock pulse from the center of a respective one of the data bits to the clock edge to a respective one of the plurality of clock pulses.

8. The method of claim 1, wherein sending the signal to reset the clock based upon the amount of timing compensation comprises sending a signal to set a new rising or falling edge for a new clock pulse based upon the amount of timing compensation.

9. The method of claim 1, wherein the filtered time information is transmitted as an analog signal having a parameter indicating a time offset between the clock and the data.

10. The method of claim 1, wherein the filtered time information is transmitted as a digital signal indicating a time offset between the clock and the data.

11. A method for compensating for signal sampling timing drift, the method comprising the steps for:
measuring raw time values between a clock and data;
filtering the measured raw time values to generate filtered time information;
comparing the filtered time information to an upper bound and a lower bound; and
based upon a determination that the filtered time information is outside the upper bound and the lower bound, performing the steps for:
computing an amount of timing compensation based upon the filtered time information; and
sending a signal to reset the clock based upon the amount of timing compensation.

12. The method of claim 11, further comprising the steps for:
repeating the steps for
measuring raw time values between a clock and data;
filtering the measured raw time values to generate filtered time information; and
comparing the filtered time information to an upper bound and a lower bound,
after sending the signal to reset the clock based upon the amount of timing compensation.

13. The method of claim 11, further comprising the steps for:
based upon a determination that the filtered time information is inside the upper bound and the lower bound, repeating the steps for:
measuring raw time values between a clock and data;
filtering the measured raw time values to generate filtered time information; and
comparing the filtered time information to an upper bound and a lower bound.

14. The method of claim 11, wherein the step for filtering the measured raw time values to generate filtered time information comprises the step for removing one or more spurious time measurement values from the measured raw time values.

15. The method of claim 11, wherein the data comprise a plurality of data bits, each of the data bits having a predetermined length and a center in a time domain, and wherein the step for computing the amount of timing compensation based upon the filtered time information comprises the step for comparing the center of a respective one of the data bits to a respective one of a plurality of clock pulses.

16. The method of claim 15, wherein the step for comparing the center of a respective one of the data bits to a respective one of a plurality of clock pulses comprises the step for comparing the center of a respective one of the data bits to a clock edge of a respective one of the plurality of clock pulses.

17. The method of claim 16, wherein the upper bound is a time delay of a fraction of a width of a clock pulse from the center of a respective one of the data bits to the clock edge of a respective one of the plurality of clock pulses, and wherein the lower bound is a time advancement of a fraction of a width of a clock pulse from the center of a respective one of the data bits to the clock edge of a respective one of the plurality of clock pulses.

18. The method of claim 11, wherein the step for sending the signal to reset the clock based upon the amount of timing compensation comprises the step for sending a signal to set a new rising or falling edge for a new clock pulse based upon the amount of timing compensation.

19. The method of claim 11, wherein the filtered time information is transmitted as an analog signal having a parameter indicating a time offset between the clock and the data.

20. The method of claim 11, wherein the filtered time information is transmitted as a digital signal indicating a time offset between the clock and the data.

21. An apparatus for compensating for signal sampling timing drift, the apparatus comprising:
means for measuring raw time values between a clock and data;
means for filtering the measured raw time values to generate filtered time information;
means for comparing the filtered time information to an upper bound and a lower bound;
means for computing an amount of timing compensation based upon the filtered time information if the filtered time information is outside the upper bound and the lower bound; and
means for sending a signal to reset the clock based upon the amount of timing compensation.

22. The apparatus of claim 21, wherein the means for filtering the measured raw time values to generate filtered time information comprises means for removing one or more spurious time measurement values from the measured raw time values.

23. The apparatus of claim 21, wherein the data comprise a plurality of data bits, each of the data bits having a predetermined length and a center in a time domain, and wherein the means for computing the amount of timing compensation based upon the filtered time information comprises means for comparing the center of each of the data bits to a respective one of a plurality of clock pulses.

24. The apparatus of claim 23, wherein the means for comparing the center of each of the data bits to a respective one of a plurality of clock pulses comprises means for comparing the center of each of the data bits to a clock edge of the respective one of the plurality of clock pulses.

25. The apparatus of claim 21, wherein the means for sending the signal to reset the clock based upon the amount of timing compensation comprises means for sending a signal to set a new rising or falling edge for a new clock pulse based upon the amount of timing compensation.

26. A non-transitory machine-readable storage medium encoded with instructions executable to perform operations to compensate for signal sampling timing drift, the instructions comprising instructions to:
measure raw time values between a clock and data;
filter the measured raw time values to generate filtered time information;
compare the filtered time information to an upper bound and a lower bound; and
based upon a determination that the filtered time information is outside the upper bound and the lower bound,
compute an amount of timing compensation based upon the filtered time information; and
send a signal to reset the clock based upon the amount of timing compensation.

27. The non-transitory machine-readable storage medium of claim 26, wherein the instructions to filter the measured raw time values to generate filtered time information comprises instructions to remove one or more spurious time measurement values from the measured raw time values.

28. The non-transitory machine-readable storage medium of claim 26, wherein the data comprise a plurality of data bits, each of the data bits having a predetermined length and a center in a time domain, and wherein the instructions to compute the amount of timing compensation based upon the filtered time information comprises instructions to compare the center of each of the data bits to a respective one of a plurality of clock pulses.

29. The non-transitory machine-readable storage medium of claim 28, wherein the instructions to compare the center of each of the data bits to a respective one of a plurality of clock pulses comprises instructions to compare the center of each of the data bits to a clock edge of the respective one of the plurality of clock pulses.

30. The non-transitory machine-readable storage medium of claim 26, wherein the instructions to send the signal to reset the clock based upon the amount of timing compensation comprises instructions to send a signal to set a new rising or falling edge for a new clock pulse based upon the amount of timing compensation.
